(19) United States
(12) Patent Application Publication
(10) Pub. No.: US 2025/0222414 A1
(43) Pub. Date: Jul. 10, 2025

(54) A SOLUTION MANAGEMENT SYSTEM FOR BIOPROCESSING

(71) Applicant: CYTIVA SWEDEN AB, Uppsala (SE)

(72) Inventors: Klas Marteleur, Uppsala (SE); Johan Alriksson, Uppsala (SE)

(21) Appl. No.: 18/852,687

(22) PCT Filed: Apr. 6, 2023
(86) PCT No.: PCT/EP2023/059247

§ 371 Date: Sep. 30, 2024

(30) Foreign Application Priority Data
Apr. 14, 2022 (GB) 2205582.6
Apr. 14, 2022 (SE) 2250464-1

(51) Int. Cl. B01F 23/45; B01F 35/21; B01F 35/213; B01F 35/214; B01F 35/71; B01F 101/00; B01F 101/44; B33Y 80/00

(52) U.S. Cl. CPC B01F 23/45; B01F 35/213; B01F 35/2131; B01F 35/2132; B01F 35/2133; B01F 35/214; B01F 35/712; B01F 35/7176; B33Y 80/00; B01F 2101/2202; B01F 2101/44

(57) ABSTRACT

A solution management system (1) for bioprocessing, wherein each flow path formed between solution inlets (2) and solution outlets (9) of the system comprises one or more bend sections having an inner cross-sectional area and/or an inner cross-sectional geometry and/or a centre line radius varying along the length of the bend section. Various embodiments of the solution management system (1) provide for improved laminar fluid flow with a reduced pressure drop between the solution inlets (2) and solution outlets (9) therein.

### TECHNICAL FIELD

The present disclosure relates to solution management system for bioprocessing.

### BACKGROUND ART

Buffer/solution production and storage can often be a bottleneck in the pharma and biotech industry. This is because many steps in buffer/solution production are manual and time consuming, and large volumes of buffer/solution need to be prepared, moved around and stored.

There is, hence a need, to solve these challenges, reduce batch failure due to operator errors, reduce labour time, reduce operational costs and space required for buffer/solution management.

### SUMMARY OF THE INVENTION

It is an object of the present invention to provide a solution management system for bioprocessing, which solves or alleviates at least some of the challenges with traditional solution and buffer management in the pharma and biotech industry.

The invention is defined by the independent patent claims. Non-limiting embodiments emerge from the dependent claims, the appended drawings and the following description.

According to a first aspect there is provided a solution management system for bioprocessing in a sterile/aseptic environment, comprising two or more solution inlets; a solution inlet tubing and/or channel connected to each solution inlet; at least one pump connected between a solution inlet tubing and/or channel and a pump outlet tubing and/or channel, generating a fluid displacement within the tubings and/or channels. The system further comprises at least one mixer zone connected with the pump outlet tubings and/or channels for mixing of solutions from the at least two solution inlets; a solution characteristic unit arranged in fluid connection with the mixer zone via a mixer zone outlet tubing and/or channel, the solution characteristic unit comprising one or more solution characteristic sensors configured to sense one or more solution characteristic values of the mixed solution, and at least one solution outlet, fluidly connected via a solution outlet tubing and/or channel with the solution characteristic unit, and arranged for discharging mixed solution from the solution management system. Each flow path formed in the system by a solution inlet tubing and/or channel, a pump outlet tubing and/or channel, the mixer zone outlet tubing and/or channel, and a solution outlet tubing and/or channel comprises one or more bend sections having an inner cross-sectional area and/or an inner cross-sectional geometry and/or a centre line radius varying along at least a portion of the length of the bend section.

As each flow path formed by a solution inlet tubing/channel, a pump outlet tubing/channel, the mixer zone outlet tubing/channel, and a solution outlet tubing/channel comprises one or more bend sections having an inner cross-sectional area and/or an inner cross-sectional geometry and/or a centre line radius varying along at least a portion of the length of the bend section (or varying along a major part of the bend section or varying along the full length of the bend section), this may lead to a reduced problem with hold-up volumes in the system, steady state flow may be reached faster, lower backpressure after the pump, less risk of stagnant zones in the tubes, a more plug-like flow in the tubings/channels, a lower pressure drop between two ends of a tubing/channel separated by a bend, and a smoother laminar flow, as compared to systems comprising traditional pipes and tubings with right-angled bends a bend section having an inner cross-sectional area and/or an inner cross-sectional geometry and/or a centre line radius varying along the length of the bend section. As well as reducing backpressure, lower hold-up volumes also provide for a reduced bioburden (e.g. of trapped biological contaminants) in the solution management system. Improved substantially laminar fluid flow (e.g. over an increased pressure operating range) can also be designed into the overall solution management system (e.g. between the inlet tubing/channel and the solution outlet tubing/channel), which system may itself contain a plurality of components fluidly connected by respective bend sections/tubes/channels/pipes.

A bend section having an inner cross-sectional area and/or an inner cross-sectional geometry and/or a centre line radius varying along at least a portion of the length of the bend section may have a circular or non-circular shaped bend section inlet (may be of any geometrical shape), a circular or non-circular shaped bend section outlet (may be of any geometrical shape). In between the bend section inlet and outlet there is a bend section characterized in that it has an inner cross-sectional area and/or an inner cross-sectional geometry and/or a centre line radius varying at least along a portion of the length of the bend section.

The flow path and the one or more bend sections may be chosen and optimised both from a flow perspective (i.e. flow rate) and from a manufacturing perspective.

A right-angled bend is a sharp bend that turns through approximately ninety degrees and having an inner cross-sectional area and/or an inner cross-sectional geometry and/or a centre line radius not varying along the length of the bend section.

The solution inlet tubing/channel, the pump outlet tubing/channel, the mixer zone outlet tubing/channel, and/or the solution outlet channel may be constituted by or may comprise one or more such bend sections.

Preferably, two, three or all of the different tubings/channels making up a flow path in the system comprise one or more bend sections having an inner cross-sectional area and/or an inner cross-sectional geometry and/or a centre line radius varying along at least a portion of the length of the bend section.

A majority of pressure losses in fluid flows occur through viscous dissipations along the course of flow. Minor losses occur when there is a change in the flow direction or geometry along the flow path. Sudden expansions, contractions, bends, and leaks cause disturbances in the form of turbulence, vortices, and flow separation. Using tubing/channels with one or more bend sections having an inner cross-sectional area and/or an inner cross-sectional geometry and/or a centre line radius varying along at least a portion of the length of the bend section, some of these limitations can be reduced.

At least one flow path formed by a respective solution inlet tubing and/or channel, a respective pump outlet tubing and/or channel, a respective mixer zone outlet tubing and/or channel, and a respective solution outlet tubing and/or channel comprises at least two, three, four or more bend sections having an inner cross-sectional area and/or an inner cross-sectional geometry and/or a centre line radius varying along at least a portion of the length of the bend section.

In a flow path, at least two of, at least three of, or each of the solution inlet tubing and/or channel, the pump outlet tubing and/or channel, the mixer zone outlet tubing and/or channel, and the solution outlet tubing and/or channel may comprise one or more bend sections having an inner cross-sectional area and/or an inner cross-sectional geometry and/or a centre line radius varying along at least a portion of the length of the bend section.

The more of the tubings/channels that are provided with one or more bend sections with non-constant radius of curvature and/or non-constant cross-section, the better the effects discussed above may be.

A pressure drop between an inlet and outlet of a substantially 90° bend section having an inner cross-sectional area and/or an inner cross-sectional geometry and/or a centre line radius varying along at least a portion of the length of the bend section, as compared to a corresponding substantially 90° bend section with an inner cross-sectional area and/or an inner cross-sectional geometry and/or a centre line radius not varying along the length of the bend section, can be reduced by at least 20% at a solution flow rate of 2000-2400 l/h trough the tubing and/or channel section.

With a substantially 90° bend section is here meant about a 85°-95° or 87°-93°, or 88°-92° bend section.

The solution flow rate may be 2000-2400 l/h or 2100-2300 l/h, or about 2200 l/h.

In a flow path, at least one of the solution inlet tubing and/or channel, the pump outlet tubing and/or channel, the mixer zone outlet tubing and/or channel, and the solution outlet tubing and/or channel may comprise at most three or at most two connected tubing and/or channel sections.

By for example using additive manufacturing for producing different tubing/channel sections, the number of separate tubing/channel sections assembled to form the flow path may be reduced and the number of joints in the flow path may be reduced. With a larger complex system, you can get a larger reduction of the number of joints than if you have a small non-complex system.

In one embodiment, in a flow path at least one of the solution inlet tubing and/or channel, the pump outlet tubing and/or channel, the mixer zone outlet tubing and/or channel, the solution outlet tubing and/or channel and/or the mixing zone is formed through additive manufacturing.

The solution inlets, solution outlets and the solution characteristic unit may be accessible from outside of the system.

The solution inlets and solution outlets may be arranged on different sides of the system.

When a convex hull encloses the system or a substantial part thereof, solution inlets, solution outlets and the solution characteristic unit may be accessible from outside of the convex hull.

Thereby, components that are used often are easily accessible for the user.

With convex hull is meant an imaginary smallest cover covering the system.

The solution management system may define a confined volume, wherein solution inlets, solution outlets and the solution characteristic unit are accessible from outside of the confined volume.

The solution inlets and solution outlets may then be arranged on different sides of the convex hull.

The solution inlets and solution outlets may be arranged on different sides of the confined volume.

The different sides at which the inlets and outlets are accessible may be two adjacent sides or two opposite sides of the confined volume/convex hull.

The system may further comprise a cover covering at least a portion of the confined volume.

The cover may fully cover the solution management system. The cover may partially cover the system and may for example have open or partially open or openable sides or roof. The cover may have the shape of a substantially rectangular or cuboid box. At least portions of the cover may be transparent or semi-transparent.

A wet working area may be arranged at the same side of the system as the solution characteristic unit.

The solution characteristic unit may comprise one or more solution characteristic sensors, selected from one or more pH sensors, one or more conductivity sensors, and/or one or more optic sensors.

The solution characteristic unit may further comprise one or more retractable pH sensors.

### BRIEF DESCRIPTION OF THE DRAWINGS

FIGS. 1 to 4 show a solution management system from different angles.

FIGS. 5 and 6 illustrate the solution management system of FIGS. 1-4 from two different views with a cover covering parts of the system.

FIGS. 7a-7c show, from different angles, different bend sections of the flow path in the solution management system.

### DETAILED DESCRIPTION

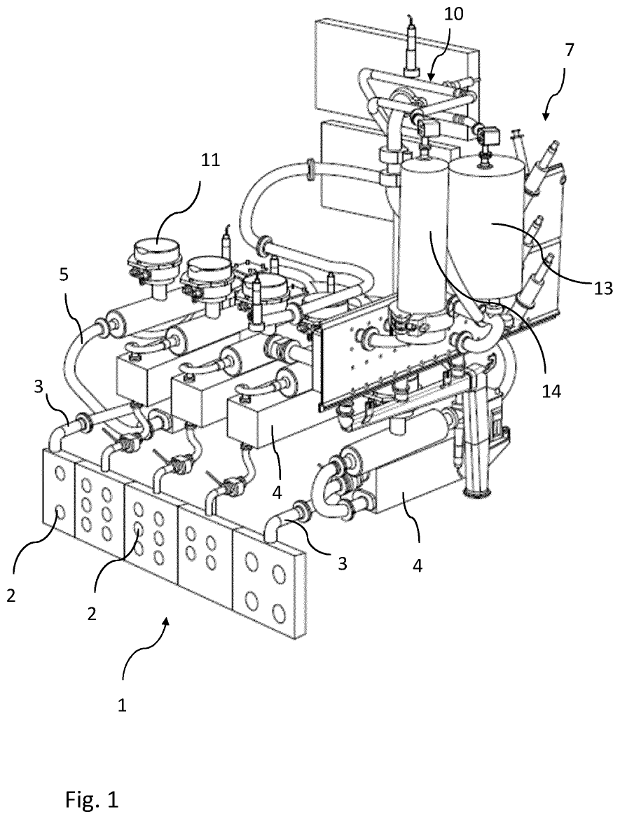

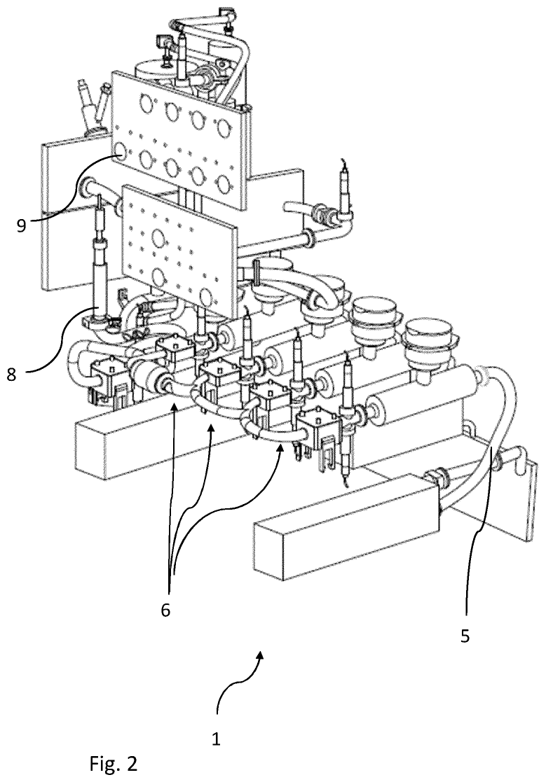

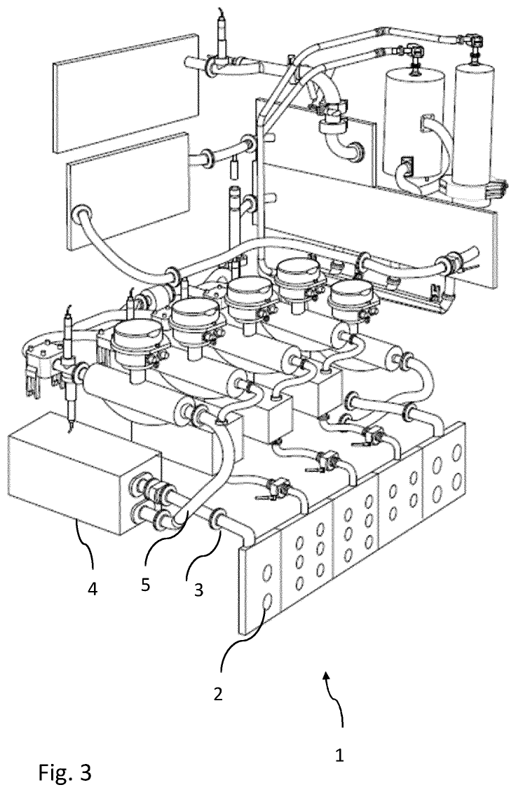

Below and in FIGS. 1-6 is described a solution management system for bioprocessing. Such a solution management system, as compared to traditional solution and buffer management in the pharma and biotech industry, can reduce batch failure due to operator errors, reduce labour time, reduce operational costs and space required for solution/buffer management.

FIGS. 1-4 show the solution management system 1 from different angles. The flow path of the solution management system 1 starts at the two or more solution inlets 2, each connected with at least one pump 4 via a solution inlet tubing and/or channel 3. Through the solution inlets 2, different solutions are entered into the system. The solutions may for example be different buffers, water, acid, salt, base, additive etc. The system may for example comprise at least one buffer solution inlet, one water inlet, one base inlet, one acid inlet, and one additive inlet. Valves may be arranged at inlets/outlets to control the flow of solution into/out of the system. The one or more pumps 4 are arranged to draw fluid from the inlets 2 through the respective solution inlet tubings/channels 3 and thereafter pump the drawn fluid out into the system through pump outlet tubings/channels 5 to generate a fluid displacement within the tubings/channels.

From the pumps 4 the flow path continues in a respective pump outlet tubing and/or channel 5. The pumps 4 are arranged to generate a fluid displacement within the tubings and/or channels. A least one mixer zone 6 is connected with the pump outlet tubings and/or channels 5 for mixing of solutions from the at least two solution inlets 2. The at least one mixer zone 6 may for example be a static mixer or a mixture junction, such as a T-, or Y-junction.

A solution characteristic unit 7 is arranged in fluid connection with the mixer zone 6 via a mixer zone outlet tubing and/or channel 8. The solution characteristic unit 7 comprises one or more solution characteristic sensors configured to sense one or more solution characteristic values of the mixed solution. The one or more solution characteristic sensors may, for example, be one or more pH sensors, one or more conductivity sensors, and/or one or more optical sensors (such as an UV sensor). The system 1 may further comprise one or more flow sensors 11 and/or one or more pressure sensors 11 and/or one or more temperature sensors 11, which may be arranged in connection with/after a pump 4.

Based on the solution characteristics detected by the one or more solution characteristic sensors, characteristic values of the mixed solution may be registered in the solution characteristic unit 7. The solution characteristic unit 7 may comprise a processor for receiving such measured values, and for processing the values and generating (a) solution characteristic signal(s) indicative of the sensed value(s). Such a solution characteristic signal may for example be generated if the solution characteristic value(s) is/are deviating from a desired value for the certain solution being produced by the system. The solution characteristic signal may comprise information regarding the degree of deviation of the characteristic value from the desired value. A signal may or may not be raised if the characteristic value is equal to or within predetermined margins of deviation from the desired value. The solution characteristic unit/processor may be arranged to communicate with inlet valves at the solution inlets 2 for buffer/base/acid/salts/water/additive, and/or with the pumps 4 such as to increase/decrease/stop addition of e.g. base to the solution that is mixed. The processor may be arranged in/built in the system or be (wirelessly) connected to the system and arranged outside/at a distance from the system. Characteristics measured may be visualised on a monitor in (wireless) connection with the processor. The monitor may be accessible from outside of the system or be arranged outside/at a distance from the system.

The system 1 has at least one solution outlet 9, which is fluidly connected via a solution outlet tubing and/or channel 10 with the solution characteristic unit 7. The solution outlet 9 being arranged for discharging mixed solution from the solution management system. The at least one solution outlet 9 may comprise a waste solution outlet for discharging mixed solution not meeting predetermined characteristic values and (a) solution outlet(s) for mixed solution meeting the predetermined characteristic values. Alternatively, there is no defined outlet point for waste. Any outlet port or drain port can be used for this purpose.

To the solution outlet(s) can be connected with solution storage containers. Alternatively, the solution management system can be directly connected via the solution outlet with for example a chromatography system (not illustrated). In yet an alternative, the solution management system can be integrated in for example a chromatography system (not illustrated).

The system may further comprise for example an air trap unit 13 and various filters 14 arranged before/after the characteristics unit 7.

Above is mentioned tubings, which could be traditional tubings, while channels could be channels integrated in fluid blocks for example.

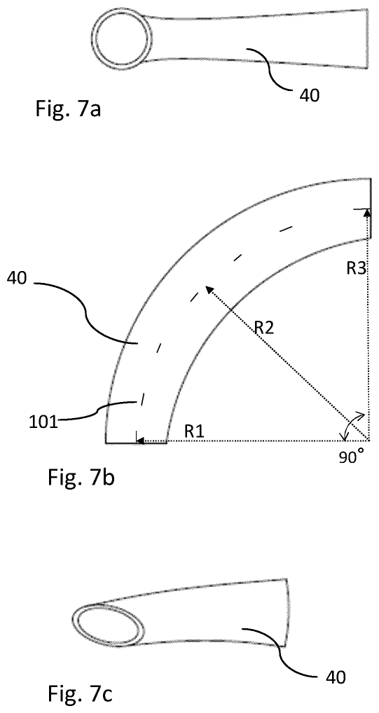

Each flow path formed by a solution inlet tubing and/or channel 3, a pump outlet tubing and/or channel 5, the mixer zone outlet tubing and/or channel 8, and a solution outlet tubing and/or channel 10 comprises one or more bend sections 40 having an inner cross-sectional area and/or an inner cross-sectional geometry and/or a centre line radius varying along at least a portion of the length of the bend section (see FIGS. 7a-7c).

An inlet and our outlet of such a bend section 40 may be circular, FIG. 7a, or non-circular, FIG. 7c. The geometry of the inlet/outlet may, alternatively, be of any geometrical shape. The shape of the inlet/outlet of a bend section may be chosen such as to facilitate connections to other parts of the system. In between the bend section inlet and outlet there is a bend section characterized in that it has an inner cross-sectional area and/or an inner cross-sectional geometry and/or a centre line radius, see FIG. 7b, varying along at least a portion of the length of the bend section. In FIG. 7b a 90° bend section is shown with the centre line/centre line axis 101 marked. As can be seen, the centre line radius R1, R2, R3 is here varying along the 90° bend section, herein R2 is shorter than R1 and R3.

Depending on the system size, the length and maximum cross-section diameter of the bend section may vary. A minimum length of the above discussed bend section may be at least 5 cm or at least 10 cm.

As each such flow path comprises one or more such bend sections 40, there may be a reduced problem with hold-up volumes in the system as compared to flow paths only comprising bends with inner cross-sectional area and/or inner cross-sectional geometry and/or centre line radius not varying along the length of the bend section. Moreover, by providing variable cross-sectional geometry and/or variable curvature of one or more of the fluid channel(s), reduced pressure drop etc. can also be achieved.

Further, the presence of such free formed tubing/channel sections may result in that steady state flow may be reached faster, lower backpressure after the pump, less risk of stagnant zones in the tubes/channels, a more plug-like flow in the tubings/channels, a lower pressure drop between two ends of a tubing/channel separated by a bend, and a smoother laminar flow, as compared to systems comprising traditional pipes and tubings with right-angled bends.

A majority of pressure losses in fluid paths occur through viscous dissipations along the course of flow. Minor losses occur when there is a change in the flow direction or geometry along the flow path. Sudden expansions, contractions, bends, and leaks cause disturbances in the form of turbulence, vortices, and flow separation. Using the discussed bend sections 40, some of these limitations can be reduced.

The solution inlet tubing/channel 2, the pump outlet tubing/channel 5, the mixer zone outlet tubing/channel 8, and/or the solution outlet tubing/channel 10 may be constituted by or may comprise one or more such bend sections 40.

In some systems 1, two, three or all of the different tubings/channels making up a flow path in the system comprise one or more free formed tubing/channel sections containing bend sections 40 with an inner cross-sectional area and/or an inner cross-sectional geometry and/or a centre line radius varying along the length of the bend section. The more of the tubings/channels that are provided with such bend sections 40, the better the effects discussed above may be.

As a comparative example, a pressure drop between an inlet and outlet of such a bend section 40 with a substantially 90° bend, as compared to a corresponding tubing section comprising a substantially 90° bend with an inner cross-sectional area and/or an inner cross-sectional geometry and/or a centre line radius not varying along the length of the bend section, i.e. having a constant radius of curvature and a constant cross-section, can be reduced by at least 20% at a solution flow rate of 2000-2400 l/h trough the tubing and/or channel section.

The volume integral of vorticity may be decreased by at least 25% and velocity uniformity increased with about 1% in the above comparative example.

In one embodiment, at least one of the solution inlet tubing and/or channel 2, pump outlet tubing and/or channel 5, the mixer zone outlet tubing and/or channel 8, solution outlet tubing and/or channel 10 and/or the mixing zone 6 is formed through additive manufacturing.

Using additive manufacturing, the shape and size of different parts of the flow path, as well as the mixer zone and other parts of the system, such as valve components and inlets/outlets, can be free formed and be adapted and/or optimised for the present system 1. By using free formed tubings/channels, the size of the system 1 can be made smaller and adapted to the space preferred, compared to when traditional ready-made tubings/pipes are used. Further, it is possible to reduce the number of connected parts forming a tubing/channel section or the mixer zone. Instead, the part can be made in one piece or a fewer amount of pieces than if ready-made tubings/pipes are used.

The hold-up volume may, for example, be reduced with 30% or more compared to the conventional reference instrument. This is possible due to the “design freedom” that 3D printing gives.

3D printing may be performed in polypropylene (PP), polyetherketone (PEEK), stainless steel or other materials compatible with typical bioprocess process fluids and cleaning agents. Parts not wetted, such as supporting components etc., may be printed in polyamide (PA) or the like. Such 3D printed parts may also be printed and/or surface treated to enable optimised cleaning or minimised biological contaminant adherence to be obtained (e.g. by way of surface heat treatment—see PCT/EP23/053794 and/or GB2213862.2 which are hereby incorporated by reference, etc.).

As many parts of the system can be 3D printed and printed in different plastic materials, the CO₂-footprint of the production of such a system is reduced as compared to systems comprising more metal parts. Further, as the system may have many parts printed in plastics, the system weigh less. The free formed parts also facilitate the production of a system having an overall smaller size. Thereby, the system 1 is, for example, easier to move around.

The solution management system 1 may define a confined volume, wherein solution inlets 2, solution outlets 9 and the solution characteristic unit 7 may be accessible from outside of the confined volume. When a convex hull encloses the system, solution inlets 2, solution outlets 9, and the solution characteristic unit 7 may be accessible from outside of the convex hull. Thereby, components that are used often are easily accessible for the user. The solution inlets and solution outlets may be arranged on different sides of the confined volume/convex hull, as illustrated in FIGS. 1-4. The different sides at which the inlets and outlets are accessible may be two adjacent sides or two opposite sides of the confined volume/convex hull.

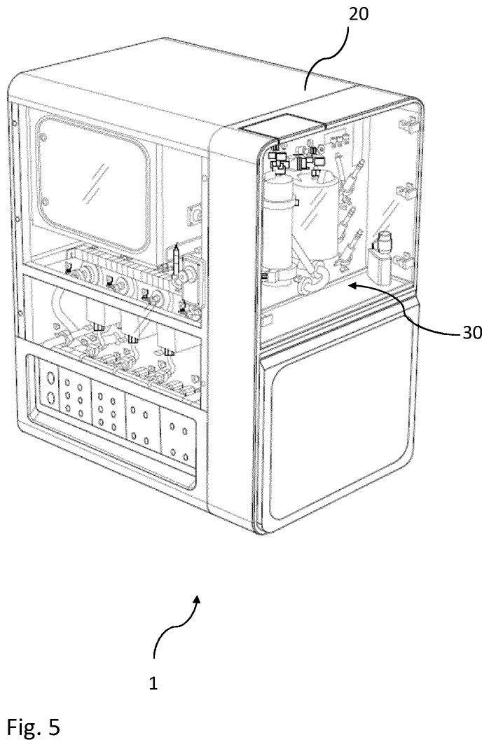

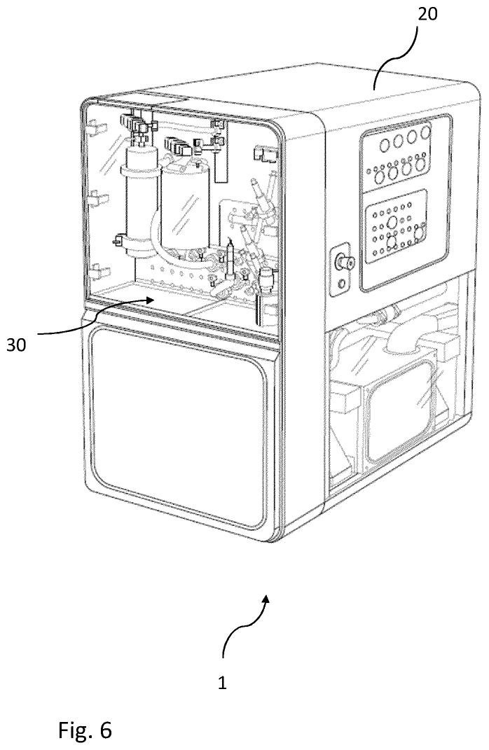

As illustrated in FIGS. 5 and 6, the system 1 may further comprise a cover 20 covering at least a portion of the confined volume. The cover 20 may fully cover the solution management system. The cover may partially cover the system and may for example have open or partially open or openable sides or roof. The cover may have the shape of a rectangular box. At least one portion of the cover may be transparent or semi-transparent. The cover or at least parts thereof may be made of plastics. The cover or parts of the cover may be mounted to the system using magnets (thereby there is a quick connection of the cover to the system and no tools are needed for accessing the system from the outside). The cover also has a function to protect a user and to minimize need for daily cleaning of the system. Further, the cover hides tubings/channels, actuators, cables etc. from the user such that only interaction points are shown for the user.

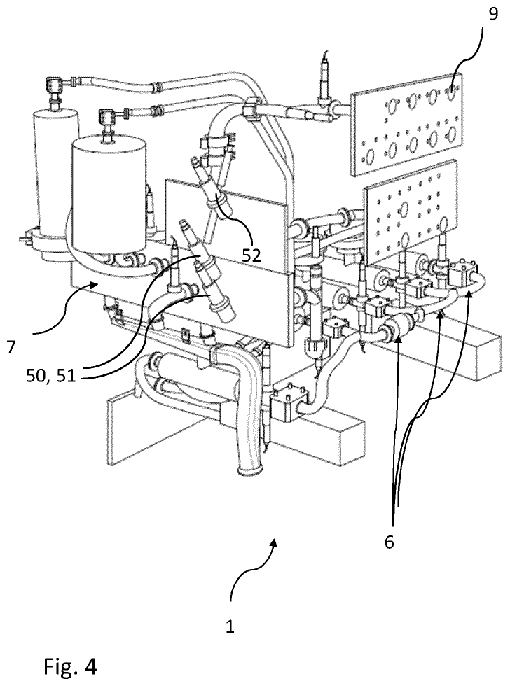

As illustrated in FIGS. 5 and 6, the system 1 may comprise a wet working area 30. The wet working area 30 is preferably arranged at the same side of the system 1 as the solution characteristic unit 7 and is readily accessible from outside of the confined volume. The wet working area may be covered with a cover which may be transparent and openable. Thereby, most system operator interfaces are arranged on the same side/place of the system. The wet working area 30 is preferably arranged at a suitable working height for a user of the system. This wet working area 30 may comprise a bench for placing different kind of vessels, calibration fluids, tools, gaskets and clamps on. The bench may comprise a drip tray for spillage, which drip tray may be removable for cleaning. The drip tray may in one embodiment be in fluid connection with a waste outlet. From this wet working area 30 an operator of the system 1 has access to the characterization unit 7, the air trap unit 13 and various filters 14. Behind the drip tray can be arranged a wall for hanging tools and accessories. It may be possible to integrate lighting at the working area 30 for even better usability. This area is, once inlets, outlets, and possibly chromatography column has been set up, preferably the only interaction side of the instrument 1. From this area it may for example be possible to calibrate pH sensors 50, 51, 52 (see FIG. 4) used in the system, change filters etc. At least one of the pH sensors 50, 51, 52 may be retractable from the characterization unit 7. Moreover, such pH sensors may thus all be provided at substantially the same accessible location, which makes the system more readily operable since (in contrast to various conventional systems) the user does not have to try any access sensors or components that are located at the side or rear of the system or which may be located within the inner tubing thereof.

1. A solution management system (1) for bioprocessing, comprising:
two or more solution inlets (2);
a solution inlet tubing and/or channel (3) connected to each solution inlet (2);
at least one pump (4) connected between a solution inlet tubing and/or channel (3) and a pump outlet tubing and/or channel (5), generating a fluid displacement within the tubings and/or channels,
at least one mixer zone (6) connected with the pump outlet tubings and/or channels (5) for mixing of solutions from the at least two solution inlets (2);
a solution characteristic unit (7) arranged in fluid connection with the mixer zone (6) via a mixer zone outlet tubing and/or channel (8), the solution characteristic unit comprising one or more solution characteristic sensors configured to sense one or more solution characteristic values of the mixed solution,
at least one solution outlet (9), fluidly connected via a solution outlet tubing and/or channel (10) with the solution characteristic unit (7), and arranged for discharging mixed solution from the solution management system (1),
wherein each flow path formed by a solution inlet tubing and/or channel (3), a pump outlet tubing and/or channel (5), the mixer zone outlet tubing and/or channel (8), and a solution outlet tubing and/or channel (10) comprises one or more bend section(s) having an inner cross-sectional area and/or an inner cross-sectional geometry and/or a centre line radius varying along at least a portion of the length of the bend section.

2. The solution management system (1) of claim 1, wherein at least one flow path formed by a respective solution inlet tubing and/or channel (3), a respective pump outlet tubing and/or channel (5), a respective mixer zone outlet tubing and/or channel (8), and a respective solution outlet tubing and/or channel (10) comprises at least two, three, four or more bend sections having an inner cross-sectional area and/or an inner cross-sectional geometry and/or a centre line radius varying along at least a portion of the length of the bend section.

3. The solution management system (1) of claim 1 or 2, wherein in a flow path at least two of, at least three of, or each of the solution inlet tubing and/or channel (3), the pump downstream tubing and/or channel (5), the mixer zone downstream tubing and/or channel (8), and the solution outlet tubing and/or channel (10) comprise one or more bend sections having an inner cross-sectional area and/or an inner cross-sectional geometry and/or a centre line radius varying along at least a portion of the length of the bend section.

4. The solution management system (1) of any of claims 1-3, wherein a pressure drop between an inlet and outlet of a substantially 90° bend section having an inner cross-sectional area and/or an inner cross-sectional geometry and/or a centre line radius varying along at least a portion of the length of the bend section, as compared to a corresponding substantially 90° bend section with an inner cross-sectional area and/or an inner cross-sectional geometry and/or a centre line radius not varying along the length of the bend section, is reduced by at least 20% at a solution flow rate of about 2000-2400 l/h trough the tubing and/or channel section.

5. The solution management system (1) of any of claims 1-4, wherein in a flow path at least one of the solution inlet tubing and/or channel (3), the pump outlet tubing and/or channel (5), the mixer zone outlet tubing and/or channel (8), the solution outlet tubing and/or channel (10) and the mixing zone (6) comprises at most three or at most two connected tubing and/or channel sections.

6. The solution management system (1) of any of the preceding claims, wherein in a flow path at least one of the solution inlet tubing and/or channel (3), the pump outlet tubing and/or channel (5), the mixer zone outlet tubing and/or channel (8), the solution outlet tubing and/or channel (10) and/or the mixing zone (6) is formed through additive manufacturing.

7. The solution management system (1) of any of the preceding claims, wherein solution inlets (2), solution outlets (9) and the solution characteristic unit (7) are accessible from outside of the system (1).

8. The solution management system of any of the preceding claims, wherein the solution inlets and solution outlets (9) are arranged on different sides of the system (1).

9. The solution management system (1) of any of the preceding claims, wherein when a convex hull encloses the system, solution inlets (2), solution outlets (9) and the solution characteristic unit (7) are accessible from outside of the convex hull.

10. The solution management system of claim 9, wherein the solution inlets and solution outlets (9) are arranged on different sides of the convex hull.

11. The solution management system (1) of any of claims 1-10, further comprising a cover (20) covering at least a portion of the system (1).

12. The solution management system (1) of any of the preceding claims, further comprising a wet working area (30).

13. The solution management system (1) of claim 12, wherein the wet working area (30) is arranged at the same side of the system (1) as the solution characteristic unit (7).

14. The solution management system (1) of any of the preceding claims, wherein the solution characteristic unit (7) comprises one or more solution characteristic sensors.

15. The solution management system (1) of claim 14, wherein, the one or more solution characteristic sensors are selected from one or more pH sensors, one or more conductivity sensors, and/or one or more optical sensors.

16. The solution management system of claim 14 or 15, wherein the solution characteristic unit (7) comprises one or more retractable pH sensor(s).

17. The solution management system (1) of claim 14, 15 or 16, wherein the one or more solution characteristic sensors are provided at a wet working area (30).
